(19) United States
(12) Patent Application Publication
(10) Pub. No.: US 2024/0413921 A1
(43) Pub. Date: Dec. 12, 2024

(54) METHOD AND NETWORK DEVICE FOR PTP CLOCK SYNCHRONIZATION

(71) Applicant: Telefonaktiebolaget LM Ericsson (publ), Stockholm (SE)

(72) Inventors: Jun WANG, Beijing (CN); LiQing LIN, Beijing (CN); Xing QIN, Beijing (CN)

(21) Appl. No.: 18/700,546

(22) PCT Filed: Oct. 11, 2021
(86) PCT No.: PCT/CN2021/123076

§ 371 Date: Apr. 11, 2024

(51) Int. Cl. H04J 3/06

(52) U.S. Cl. CPC H04J 3/0667

(57) ABSTRACT

A method and a network device are disclosed for precision time protocol (PTP) clock synchronization. According to an embodiment, a network device determines first estimates of offsets between a slave clock of the network device acting as a PTP slave and a master clock of a PTP master, based on timestamps related to PTP messages communicated between the network device and the PTP master. The network device determines whether there is a change in at least one of a first path from the network device to the PTP master and a second path from the PTP master to the network device. When determining that there is a change in at least one of the first path and the second path, the network device updates the first estimate of the asymmetry based on the first estimates of the offsets.

### TECHNICAL FIELD

Embodiments of the disclosure generally relate to communication, and, more particularly, to a method and a network device for precision time protocol (PTP) clock synchronization.

### BACKGROUND

This section introduces aspects that may facilitate better understanding of the present disclosure. Accordingly, the statements of this section are to be read in this light and are not to be understood as admissions about what is in the prior art or what is not in the prior art.

Precision time protocol (PTP) is a 2-way time transfer protocol with hardware time stamping to transport the timing within Ethernet frames or Internet protocol (IP) packets. It is defined in the institute of electrical and electronics engineers (IEEE) 1588 standard that describes a master-slave architecture for timing distribution.

International telecommunication union-telecommunication standardization sector (ITU-T) G.8275.2 profile is a precision time protocol defined for phase/time synchronization with partial timing support (PTS) from the network. It is a profile for telecommunication applications based on IEEE 1588 PTP. This profile includes the case of assisted partial timing support (APTS).

PTP uses event messages to carry timestamps between master and slave clocks to carry out time calculation. FIG. 1 illustrates the message exchange procedure. Suppose that: Tof is the offset between the slave clock and the master clock, i.e. Tof=t_{Master}−t_{Slave}; t1 is the timestamp at which the Synch (or Sync) message is sent from the master; t2 is the timestamp at which the Synch message is received by the slave; t3 is the timestamp at which the Delay_Req (or Delay Request) message is sent from the slave; t4 is the timestamp at which the Delay_Req message is received by the master; Dms is the propagation delay from the master to the slave; and Dsm is the propagation delay from the slave to the master. Then, the following two equations can be obtained:

$$t 2 - t 1 = Dms + Tof , \qquad ( 1 )$$

$$t 4 - t 3 = Dsm - Tof . \qquad ( 2 )$$

By combining the above two equations, Tof can be obtained as:

$$Tof = ( t 2 - t 1 - t 4 + t 3 ) / 2 + ( D s m - Dms ) / 2. \qquad ( 3 )$$

If it is supposed that Dms=Dsm, then it is possible to exactly compute Tof.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for PTP clock synchronization. In particular, one of the problems to be solved by the disclosure is that when the delay asymmetry between the PTP forward and reverse paths changes, the existing solution could not compensate the change of the delay asymmetry in some cases (e.g. a global positioning system (GPS) clock fails to be available for the PTP slave).

According to a first aspect of the disclosure, there is provided a method performed by a network device. The method may comprise determining first estimates of offsets between a slave clock of the network device acting as a PTP slave and a master clock of a PTP master, based on timestamps related to PTP messages communicated between the network device and the PTP master. The method may further comprise determining whether there is a change in at least one of a first path from the network device to the PTP master and a second path from the PTP master to the network device. The method may further comprise, when determining that there is no change in the first path and the second path, synchronizing the slave clock with the master clock based on the first estimates of the offsets and a first estimate of asymmetry between a first propagation delay from the network device to the PTP master and a second propagation delay from the PTP master to the network device. The method may further comprise, when determining that there is a change in at least one of the first path and the second path, updating the first estimate of the asymmetry based on the first estimates of the offsets.

In this way, it is possible to compensate the change of the asymmetry even in the cases mentioned above.

In an embodiment of the disclosure, determining whether there is a change in at least one of the first path and the second path may comprise determining a second estimate of the asymmetry based on the first estimates of the offsets. Determining whether there is a change in at least one of the first path and the second path may further comprise determining whether there is a change in at least one of the first path and the second path, based on the second estimate of the asymmetry and the first estimate of the asymmetry.

In an embodiment of the disclosure, when a difference between the second estimate of the asymmetry and the first estimate of the asymmetry exceeds a predetermined threshold range, it may be determined that there is a change in at least one of the first path and the second path. When the difference is within the predetermined threshold range, it may be determined that there is no change in the first path and the second path.

In an embodiment of the disclosure, updating the first estimate of the asymmetry may comprise updating the first estimate of the asymmetry to be equal to the second estimate of the asymmetry.

In an embodiment of the disclosure, determining whether there is a change in at least one of the first path and the second path may comprise obtaining routing information related to the first path and the second path, determining whether there is a change in at least one of the first path and the second path may further comprise determining whether there is a change in at least one of the first path and the second path, based on the obtained routing information.

In an embodiment of the disclosure, the routing information may be obtained by using one or more of: a traceroute process; and an interior gateway protocol (IGP) process.

In an embodiment of the disclosure, updating the first estimate of the asymmetry may comprise determining a second estimate of the asymmetry based on the first estimates of the offsets. Updating the first estimate of the asymmetry may further comprise updating the first estimate of the asymmetry to be equal to the second estimate of the asymmetry.

In an embodiment of the disclosure, whether there is a change in at least one of the first path and the second path may be determined based on the obtained routing information and the first estimates of the offsets.

In an embodiment of the disclosure, it may be determined that there is no change in the first path and the second path when one of following conditions is satisfied: a difference between a second estimate of the asymmetry based on the first estimates of the offsets and the first estimate of the asymmetry exceeds a predetermined threshold range, but the obtained routing information shows that there is no change in the first path and the second path; and the difference is within the predetermined threshold range.

In an embodiment of the disclosure, synchronizing the slave clock with the master clock based on the first estimates of the offsets and the first estimate of the asymmetry may comprise determining a second estimate of the offset based on the first estimates of the offsets and the first estimate of the asymmetry. Synchronizing the slave clock with the master clock based on the first estimates of the offsets and the first estimate of the asymmetry may further comprise adjusting the slave clock based on the second estimate of the offset.

In an embodiment of the disclosure, the PTP messages may comprise a plurality of message groups communicated during a predetermined time period. Each message group may include a Sync message, a Follow Up message, a Delay Request message and a Delay Response message. The timestamps may comprise a plurality of timestamp groups corresponding to the plurality of message groups. Each timestamp group may include a first timestamp at which the Sync message is sent from the PTP master, a second timestamp at which the Sync message is received by the network device, a third timestamp at which the Delay Request message is sent from the network device, and a fourth time stamp at which the Delay Request message is received by the PTP master.

In an embodiment of the disclosure, for a message group, the first estimate of the offset may be determined as 0.5 multiplied by a difference between a first difference between the second and first timestamps and a second difference between the fourth and third timestamps.

In an embodiment of the disclosure, the second estimate of the asymmetry may be determined as an opposite value of an average value of: the first estimates of the offsets; or the filtered first estimates of the offsets.

In an embodiment of the disclosure, the second estimate of the offset may be determined as a sum of the first estimate of the asymmetry and an average value of the first estimates of the offsets or the filtered first estimates of the offsets.

In an embodiment of the disclosure, the network device may be one of: a partial-support telecom boundary clock (T-BC-P) device; an assisted partial-support telecom boundary clock (T-BC-A) device; a partial-support telecom time slave clock (T-TSC-P) device; and an assisted partial-support telecom time slave clock (T-TSC-A) device.

According to a second aspect of the disclosure, there is provided a network device. The network device may comprise at least one processor and at least one memory. The at least one memory may contain instructions executable by the at least one processor, whereby the network device may be operative to determine first estimates of offsets between a slave clock of the network device acting as a PTP slave and a master clock of a PTP master, based on timestamps related to PTP messages communicated between the network device and the PTP master. The network device may be further operative to determine whether there is a change in at least one of a first path from the network device to the PTP master and a second path from the PTP master to the network device. The network device may be further operative to, when determining that there is no change in the first path and the second path, synchronize the slave clock with the master clock based on the first estimates of the offsets and a first estimate of asymmetry between a first propagation delay from the network device to the PTP master and a second propagation delay from the PTP master to the network device. The network device may be further operative to, when determining that there is a change in at least one of the first path and the second path, update the first estimate of the asymmetry based on the first estimates of the offsets.

In an embodiment of the disclosure, the network device may be operative to perform the method according to the above first aspect.

According to a third aspect of the disclosure, there is provided a computer program product. The computer program product may contain instructions which when executed by at least one processor, cause the at least one processor to perform the method according to the above first aspect.

According to a fourth aspect of the disclosure, there is provided a computer readable storage medium. The computer readable storage medium may store thereon instructions which when executed by at least one processor, cause the at least one processor to perform the method according to the above first aspect.

According to a fifth aspect of the disclosure, there is provided a network device. The network device may comprise a first determination module for determining first estimates of offsets between a slave clock of the network device acting as a PTP slave and a master clock of a PTP master, based on timestamps related to PTP messages communicated between the network device and the PTP master. The network device may further comprise a second determination module for determining whether there is a change in at least one of a first path from the network device to the PTP master and a second path from the PTP master to the network device. The network device may further comprise a synchronizing module for, when determining that there is no change in the first path and the second path, synchronizing the slave clock with the master clock based on the first estimates of the offsets and a first estimate of asymmetry between a first propagation delay from the network device to the PTP master and a second propagation delay from the PTP master to the network device. The network device may further comprise an updating module for, when determining that there is a change in at least one of the first path and the second path, updating the first estimate of the asymmetry based on the first estimates of the offsets.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a PTP message exchange procedure;

FIG. 2 is a diagram illustrating an exemplary APTS deployment;

FIG. 3 is a diagram illustrating a scenario occurring in the deployment of FIG. 2;

FIG. 4 is a flowchart illustrating a method performed by a network device according to an embodiment of the disclosure;

FIG. 5 is a flowchart illustrating a method performed by a network device according to an embodiment of the disclosure;

FIG. 6 is a flowchart illustrating a method performed by a network device according to an embodiment of the disclosure;

FIG. 7 is a block diagram showing an apparatus suitable for use in practicing some embodiments of the disclosure;

FIG. 8 is a block diagram showing a network device according to an embodiment of the disclosure;

FIG. 9 is a block diagram showing a network device according to an embodiment of the disclosure;

FIG. 10 is a flowchart illustrating a method performed by the network device of FIG. 9; and

FIG. 11 is a block diagram for explaining the method of FIG. 10.

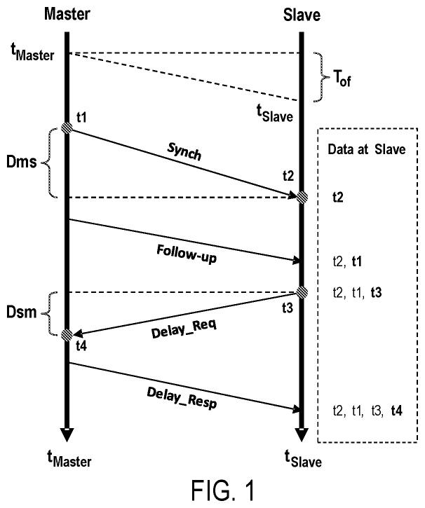

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

As mentioned above, according to equation (3), if it is supposed that Dms=Dsm, then it is possible to exactly compute Tof. However, unfortunately, in real networks there are some reasons causing Dms≠Dsm (which may be referred to as asymmetry). One kind of asymmetry is stochastic asymmetry caused by e.g. different network loads in downstream vs. upstream. Another kind of asymmetry is deterministic asymmetry caused by e.g. different physical paths in downstream vs. upstream.

A proper algorithm in the slave device can succeed in filtering out most of stochastic asymmetries, by working on a large number of measurement sets {t1(k), t2(k), t3 (k), t4 (k), k=1, . . . , N}. Deterministic asymmetries can only be removed if they are computed or measured with other methods. Otherwise, Tof estimation result will have an error ε=(Dsm−Dms)/2.

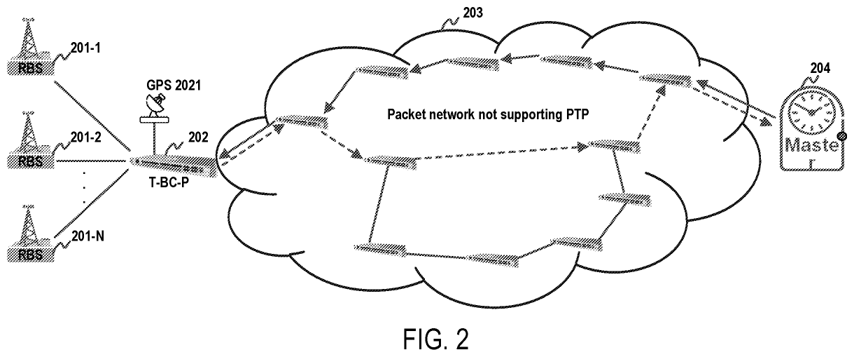

APTS is recommended to be used for G.8275.2. This is because there are deterministic asymmetries on PTP paths and they could not be removed by filtering algorithms. Using GPS as assisted reference could help to compute the asymmetry on PTP paths and compensate it when switching from GPS to PTP paths. FIG. 2 illustrates an exemplary APTS deployment according to G.8275.2. As shown, a plurality of radio base stations (RBSs) 201-1, 201-2, . . . 201-N are connected with a partial-support telecom boundary clock (T-BC-P) 202. The T-BC-P 202 is connected with a remote grandmaster (GM) 204 via a packet network 203 not supporting PTP. The GPS 2021 is the primary clock source of the T-BC-P 202 and the local clock is adjusted by the GPS 2021. The backup clock source is from the remote GM 204 via the PTP unaware network 203. Since the forward path (from the T-BC-P 202 to the GM 204) and reverse path (from the GM 204 to the T-BC-P 202) are different due to IP routing policy, there would be deterministic asymmetry on the PTP packet paths.

For G.8275.2, the backup PTP source could always have PTP packet exchanges with the remote GM. It could calculate the offset Tof compared with the local clock and record it in the system. Here Tof is calculated by using a large number of PTP timestamps according to (t2−t1−t4+t3)/2. Since the local clock is synchronized with the GPS clock and thus could be deemed as being synchronized with the GM clock, the actual Tof represented by equation (3) could be deemed as zero. Thus, the calculated Tof equals to −ε=−(Dsm−Dms)/2 which is caused by the asymmetry on the PTP packet paths. The parameter ε may be marked as compensation_A hereinbelow. Thus, for APTS use case, when the GPS is available, the deterministic asymmetry could be computed based on the GPS reference even if there is re-route happening on PTP packet path(s).

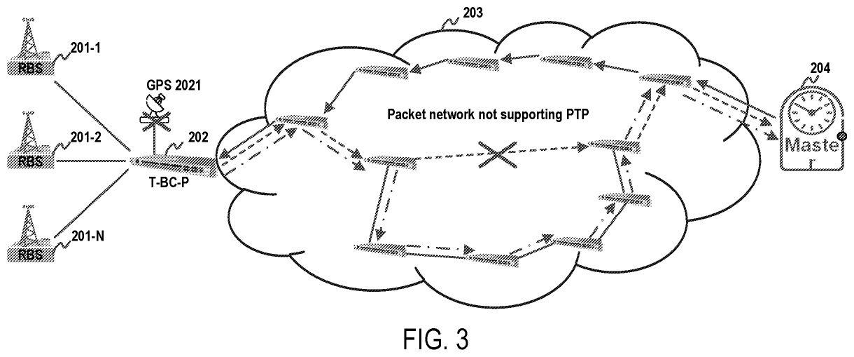

However, the existing solution may have a problem in the scenario shown in FIG. 3. Specifically, GPS is in failure or disturbed due to some reasons. Then, the T-BC-P would switch to the backup PTP source and compensate the asymmetry. In the existing solution, the compensation_A is applied to each phase adjustment for the hardware (HW) of the slave device, that is:

$$HW phase adjustment = Tof + compensation\_A . \qquad ( 4 )$$

During the GPS outage, if there is re-route happening in the PTP unaware network (e.g., as shown in FIG. 3, the forward path changes from dashed line to dot-dash line), the delay of forward direction would be increased due to adding more hops and different length of fiber between the nodes. Since the delay of the forward path changes, the asymmetry between the forward and reverse paths also changes. Since the T-BC-P still have PTP message exchanges with the remote GM and the PTP session is still available, the HW phase adjustment calculated according to equation (4) in the existing solution would have a newly introduced time error ε′ (which may also be marked as compensation_B hereinbelow):

$$\begin{matrix}ε ’ = [ Tof + ( Dsm ’ - Dms ) / 2 ] - [ Tof + compensation\_A ] \\ = ( Dsm ’ - Dsm ) / 2\end{matrix} . \qquad ( 5 )$$

Thus, the accurate phase adjustment applied to the HW of the slave device in this scenario should be:

$$HW phase adjustment = Tof + compensation\_A + compensation\_B . \qquad ( 6 )$$

The newly introduced Time Error ε′ could not be removed since there is no available reference (e.g. GPS) to detect the asymmetry. The time error would be populated to downstream radio base stations (RBSs) to cause service impact on the RBSs.

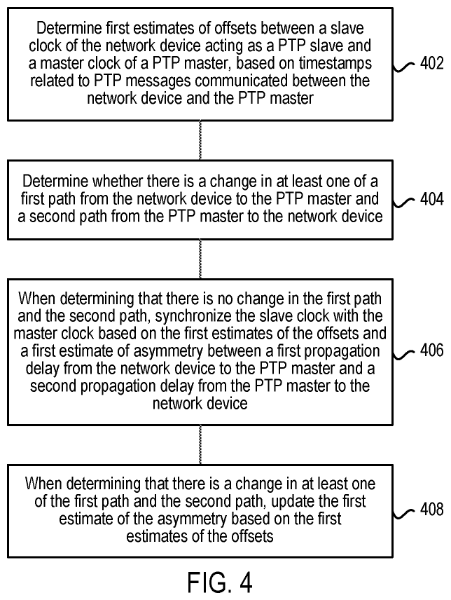

The present disclosure proposes an improved solution for PTP clock synchronization. The solution may be applicable to any network device which has PTP capability and needs to carry out clock synchronization with a master device (e.g. a grandmaster) by PTP. Examples of the network device include, but not limited to, a router, a switch, a bridge, a gateway, and the like. The network device may also be a “multiple services network device” that provides support for multiple networking functions (e.g., routing, bridging, switching, Layer 2 aggregation, session border control, quality of service, and/or subscriber management), and/or provides support for multiple application services (e.g., data, voice, and video). When carrying out PTP clock synchronization, the network device may act as any one of a T-BC-P, an assisted partial-support telecom boundary clock (T-BC-A), a partial-support telecom time slave clock (T-TSC-P), an assisted partial-support telecom time slave clock (T-TSC-A), and the like. Hereinafter, the solution will be described in detail with reference to FIGS. 4-11.

FIG. 4 is a flowchart illustrating a method performed by a network device according to an embodiment of the disclosure. As an exemplary example, the method may be used in a scenario where a GPS clock (or any other suitable reference clock) was previously available to be used for the network device and now is in failure or disturbed. At block 402, the network device determines first estimates of offsets between a slave clock of the network device acting as a PTP slave and a master clock of a PTP master, based on timestamps related to PTP messages communicated between the network device and the PTP master. For example, the PTP messages may comprise a plurality of message groups communicated during a predetermined time period. Each message group may include a Sync message, a Follow Up message, a Delay Request message and a Delay Response message. Accordingly, the timestamps may comprise a plurality of timestamp groups corresponding to the plurality of message groups. Each timestamp group may include a first timestamp (denoted as t1) at which the Sync message is sent from the PTP master, a second timestamp (denoted as t2) at which the Sync message is received by the network device, a third timestamp (denoted as t3) at which the Delay Request message is sent from the network device, and a fourth time stamp (denoted as t4) at which the Delay Request message is received by the PTP master. For a message group, the first estimate of the offset (denoted as Tof_1) may be determined as 0.5 multiplied by a difference between a first difference between the second and first timestamps and a second difference between the fourth and third timestamps. This may be expressed as:

$$Tof\_ 1 = 0.5 \cdot [ ( t 2 - t 1 ) - ( t 4 - t 3 ) ] = ( t 2 - t 1 - t 4 + t 3 ) / 2. \qquad ( 7 )$$

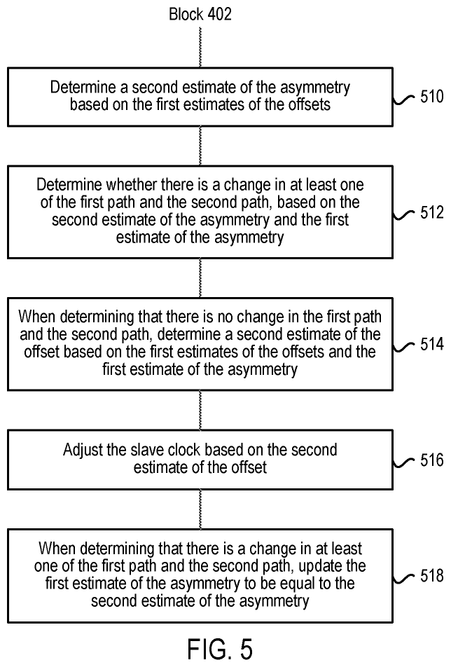

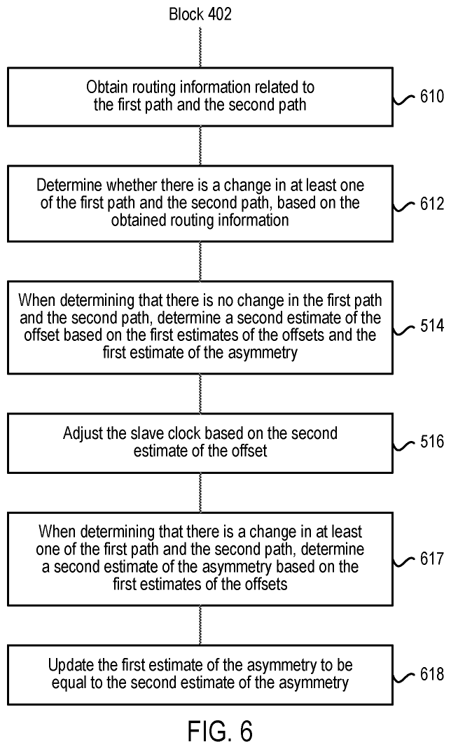

At block 404, the network device determines whether there is a change in at least one of a first path from the network device to the PTP master and a second path from the PTP master to the network device. There may be two options for implementing block 404. As the first option, block 404 may be implemented as blocks 510-512 of FIG. 5, which will be described later. As the second option, block 404 may be implemented as blocks 610-612 of FIG. 6, which will be described later.

When determining that there is no change in the first path and the second path, the network device synchronizes the slave clock with the master clock based on the first estimates of the offsets and a first estimate of asymmetry between a first propagation delay from the network device to the PTP master and a second propagation delay from the PTP master to the network device at block 406. The first propagation delay refers to the delay (or time) required for propagation of a signal from the network device to the PTP master. The second propagation delay refers to the delay (or time) required for propagation of a signal from the PTP master to the network device. As an exemplary example, the asymmetry between the first propagation delay and the second propagation delay may be represented as 0.5 multiplied by a difference between the first propagation delay and the second propagation delay, that is, (Dsm−Dms)/2.

As an example, the first estimate of the asymmetry may be determined when the GPS clock was previously available to be used for the network device. Specifically, in the state where the GPS clock was available, an offset Tof_0 may be calculated by using a large number of PTP timestamps according to (t2−t1−t4+t3)/2. Since the local clock of the network device may be synchronized with the available GPS clock and thus may be deemed as being synchronized with the master clock, the actual offset represented by equation (3) may be deemed as zero. Thus, the first estimate of the asymmetry (denoted as D_{asymmetry_1}) may be calculated as: D_{asymmetry_1}=(Dsm−Dms)/2=−Tof_0.

As another example, the network device may be provided with no GPS and thus a GPS clock is always unavailable for the network device. In this case, the first estimate of the asymmetry may be determined by additionally connecting the network device with a local GM when the first path and the second path have been configured between the network device and the PTP master. After the first estimate of the asymmetry is determined, the local GM may be disconnected from the network device.

For example, block 406 may be implemented as blocks 514-516 in FIG. 5 and FIG. 6. At block 514, the network device determines a second estimate of the offset (denoted as Tof_2) based on the first estimates of the offsets and the first estimate of the asymmetry. As a simplest example, the second estimate of the offset may be determined as a sum of the first estimate of the asymmetry and an average value of the first estimates of the offsets. As another example, the second estimate of the offset may be determined as a sum of the first estimate of the asymmetry and an average value of the filtered first estimates of the offsets. For instance, the largest one and the smallest one may be filtered out from the first estimates of the offsets. Note that any other suitable filtering algorithm may be used instead to remove stochastic asymmetrics. At block 516, the network device adjusts the slave clock based on the second estimate of the offset. For example, the determined second estimate of the offset may be applied to the slave clock of the network device according to the equation expressed as: t_{Master}=t_{Slave}+Tof_2.

On the other hand, when determining that there is a change in at least one of the first path and the second path, the network device updates the first estimate of the asymmetry based on the first estimates of the offsets at block 408. In the above first option where block 404 is implemented as blocks 510-512, block 408 may be implemented as block 518, which will be described later. In the above second option where block 404 is implemented as blocks 610-612, block 408 may be implemented as blocks 617-618, which will be described later.

In the method described above, the first estimate of the asymmetry may be initially determined either by using an available GPS clock or by connecting with a local GM. Then, the first estimate of the asymmetry may remain unchanged to be used for clock synchronization, until a change in at least one of the first path and the second path is detected. Then, the updated first estimate of the asymmetry may remain unchanged until the next time when a further change in at least one of the first path and the second path is detected. Because the first estimate of the asymmetry can be automatically updated based on the first estimates of the offsets at block 408, the change of the asymmetry can be compensated even if the GPS is in failure or disturbed or is not provided at all.

FIG. 5 is a flowchart illustrating a method performed by a network device according to an embodiment of the disclosure. As described above, in this method, block 404 is implemented as blocks 510-512, block 406 is implemented as blocks 514-516, and block 408 is implemented as block 518. At block 402, the network device determines first estimates of offsets between a slave clock of the network device acting as a PTP slave and a master clock of a PTP master, based on timestamps related to PTP messages communicated between the network device and the PTP master. At block 510, the network device determines a second estimate of the asymmetry based on the first estimates of the offsets. As described above, the first estimate of the asymmetry may be initially determined either by using an available GPS clock or by connecting with a local GM. Then, the first estimate of the asymmetry may remain unchanged to be used for clock synchronization, until a change in at least one of the first path and the second path is detected. Because the accurate first estimate of the asymmetry is used for clock synchronization, the slave clock can be deemed as being synchronized with the master clock (and thus the actual offset represented by equation (3) may be deemed as zero), before a change in at least one of the first path and the second path happens. Then, after such change happens, the slave clock can still be deemed as being approximately synchronized with the master clock within a relatively shorter time period. This means that for a given time point which is shortly after the happening of such change, a sum of the second estimate of the asymmetry (denoted as D_{asymmetry_2}) and the first estimate of the offset (denoted as Tof_1) may be deemed as being approximately equal to zero.

Thus, as a simplest example, the second estimate of the asymmetry may be determined as an opposite value of an average value of the first estimates of the offsets. As another example, the second estimate of the asymmetry may be determined as an opposite value of an average value of the filtered first estimates of the offsets. For instance, the largest one and the smallest one may be filtered out from the first estimates of the offsets. Note that any other suitable filtering algorithm may be used instead to remove stochastic asymmetries.

At block 512, the network device determines whether there is a change in at least one of the first path and the second path, based on the second estimate of the asymmetry and the first estimate of the asymmetry. For example, when a difference between the second estimate of the asymmetry and the first estimate of the asymmetry exceeds a predetermined threshold range, the network device may determine that there is a change in at least one of the first path and the second path. On the other hand, when the difference is within the predetermined threshold range, the network device may determine that there is no change in the first path and the second path. In this way, the change of the asymmetry can be detected no matter it is caused by the change of the first path, or the change of the second path, or traffic congestion getting worse or recovery, or any other events.

At block 514, when determining that there is no change in the first path and the second path, the network device determines a second estimate of the offset based on the first estimates of the offsets and the first estimate of the asymmetry. At block 516, the network device adjusts the slave clock based on the second estimate of the offset. At block 518, when determining that there is a change in at least one of the first path and the second path, the network device updates the first estimate of the asymmetry to be equal to the second estimate of the asymmetry. In this way, the change of the asymmetry can be compensated even if the GPS is in failure or disturbed or is not provided at all.

FIG. 6 is a flowchart illustrating a method performed by a network device according to an embodiment of the disclosure. As described above, in this method, block 404 is implemented as blocks 610-612, block 406 is implemented as blocks 514-516, and block 408 is implemented as blocks 617-618. At block 402, the network device determines first estimates of offsets between a slave clock of the network device acting as a PTP slave and a master clock of a PTP master, based on timestamps related to PTP messages communicated between the network device and the PTP master.

At block 610, the network device obtains routing information related to the first path and the second path. At block 612, the network device determines whether there is a change in at least one of the first path and the second path, based on the obtained routing information. The routing information related to the first/second path may comprise information about each hop on the first/second path, or may comprise information about a change in one or more hops on the first/second path. As an option, the routing information may be obtained by using a traceroute process. In this case, the routing information may be obtained at different times (e.g. periodically) so as to determine whether there is a change in at least one of the first path and the second path. As another option, the routing information may be obtained by using an interior gateway protocol (IGP) process. For example, for open shortest path first (OSPF) or intermediate system to intermediate system (ISIS), if the first/second path is changed, the link state database (LSDB) will be updated. For border gateway protocol (BGP), if the first/second path is changed, the local routing information base (RIB) database will be updated. Note that the present disclosure is not limited to the above examples and any other suitable technique for detecting path change may be used.

At block 514, when determining that there is no change in the first path and the second path, the network device determines a second estimate of the offset based on the first estimates of the offsets and the first estimate of the asymmetry. At block 516, the network device adjusts the slave clock based on the second estimate of the offset. At block 617, when determining that there is a change in at least one of the first path and the second path, the network device determines a second estimate of the asymmetry based on the first estimates of the offsets. Block 617 may be implemented in a way similar to block 510. At block 618, the network device updates the first estimate of the asymmetry to be equal to the second estimate of the asymmetry. In this way, the change of the asymmetry can be compensated even if the GPS is in failure or disturbed or is not provided at all.

Optionally, block 404 may be implemented based on the obtained routing information and the first estimates of the offsets. For example, when a difference between the second estimate of the asymmetry based on the first estimates of the offsets and the first estimate of the asymmetry is within a predetermined threshold range, the network device may directly determine that there is no change in the first path and the second path. When the difference exceeds the predetermined threshold range, but the obtained routing information shows that there is no change in the first path and the second path, the network device may determine that there is no change in the first path and the second path. When the difference exceeds the predetermined threshold range, and the obtained routing information shows that there is a change in at least one of the first path and the second path, the network device may determine there is a change in at least one of the first path and the second path.

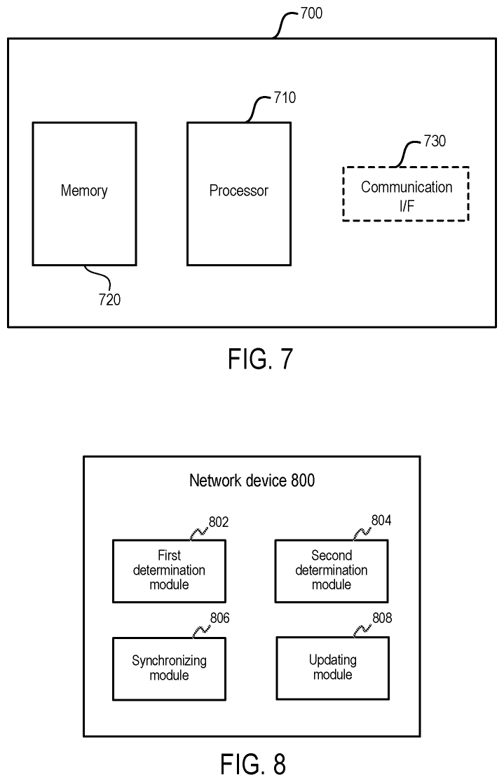

FIG. 7 is a block diagram showing an apparatus suitable for use in practicing some embodiments of the disclosure. For example, the network device described above may be implemented through the apparatus 700. As shown, the apparatus 700 may include a processor 710, a memory 720 that stores a program, and optionally a communication interface 730 for communicating data with other external devices through wired and/or wireless communication.

The program includes program instructions that, when executed by the processor 710, enable the apparatus 700 to operate in accordance with the embodiments of the present disclosure, as discussed above. That is, the embodiments of the present disclosure may be implemented at least in part by computer software executable by the processor 710, or by hardware, or by a combination of software and hardware.

The memory 720 may be of any type suitable to the local technical environment and may be implemented using any suitable data storage technology, such as semiconductor based memory devices, flash memories, magnetic memory devices and systems, optical memory devices and systems, fixed memories and removable memories. The processor 710 may be of any type suitable to the local technical environment, and may include one or more of general purpose computers, special purpose computers, microprocessors, digital signal processors (DSPs) and processors based on multi-core processor architectures, as non-limiting examples.

FIG. 8 is a block diagram showing a network device according to an embodiment of the disclosure. As shown, the network device 800 comprises a first determination module 802, a second determination module 804, a synchronizing module 806 and an updating module 808. The first determination module 802 may be configured to determine first estimates of offsets between a slave clock of the network device acting as a PTP slave and a master clock of a PTP master, based on timestamps related to PTP messages communicated between the network device and the PTP master, as described above with respect to block 402. The second determination module 804 may be configured to determine whether there is a change in at least one of a first path from the network device to the PTP master and a second path from the PTP master to the network device, as described above with respect to block 404. The synchronizing module 806 may be configured to, when determining that there is no change in the first path and the second path, synchronize the slave clock with the master clock based on the first estimates of the offsets and a first estimate of asymmetry between a first propagation delay from the network device to the PTP master and a second propagation delay from the PTP master to the network device, as described above with respect to block 406. The updating module 408 may be configured to, when determining that there is a change in at least one of the first path and the second path, update the first estimate of the asymmetry based on the first estimates of the offsets, as described above with respect to block 408. The modules described above may be implemented by hardware, or software, or a combination of both.

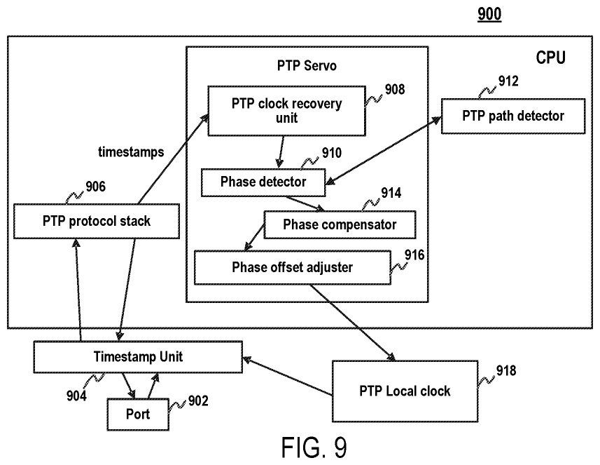

FIG. 9 is a block diagram showing a network device according to an embodiment of the disclosure. As shown, the network device 900 comprises a port 902, a timestamp unit 904, a PTP protocol stack 906, a PTP clock recovery unit 908, a phase detector 910, a PTP path detector 912, a phase compensator 914, a phase offset adjuster 916 and a PTP local clock 918. PTP packets may be received on the port 902 and timestamped in the timestamp unit 904. The transmitted PTP packets may also be timestamped in the timestamp unit 904 and sent out by the port 902. Note that although one port 902 is shown, there may be multiple ports 902 in the network device 900. The received PTP packets may be trapped to the PTP protocol stack 906 in the central processing unit (CPU) of the network device 900. The PTP protocol stack 906 may parse the packets and retrieve timestamps (t1, t2, t3, t4) and send them to the PTP servo. The PTP clock recovery unit 908 may calculate the first estimates of the offsets from the PTP master according to a large number of timestamps. The first estimate of the offset has been described above with respect to block 402.

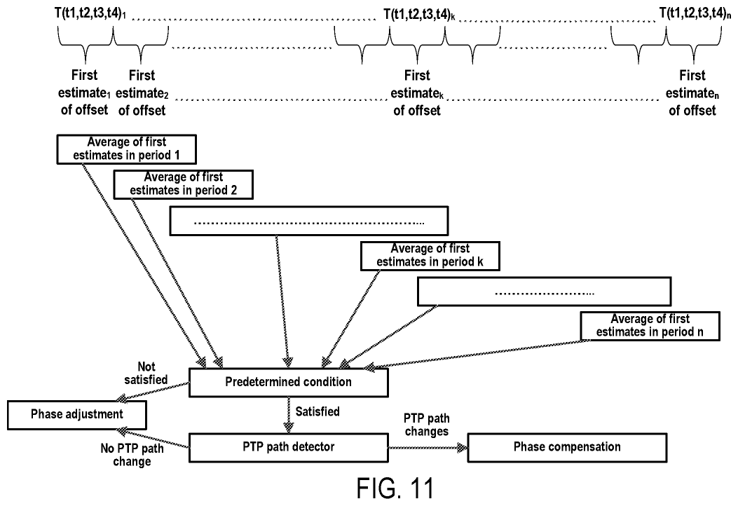

The phase detector 910 may be configured to continually monitor the first estimates of the offsets calculated by the PTP clock recovery unit 908, by performing blocks 1004-1005 of FIG. 11 which will be described later. The PTP path detector 912 may be configured to detect whether there is any path change for PTP packets for both uplink and downlink directions. The phase compensator 914 may be configured to compensate the change of the asymmetry when it is detected by the phase detector 910 and the PTP path detector 912. The three components 910, 912 and 914 may work only when PTP is in locked state. The PTP locked state may refer to the state where the PTP local clock has been synchronized with the PTP master and the first estimate of the asymmetry mentioned above has been determined e.g. by using either an available GPS clock or by connecting with a local GM. The phase adjuster 916 may determine the second estimate of the offset and apply it to the PTP local clock 918. The second estimate of the offset has been described above with respect to block 514.

According to the above description, in this embodiment, the components 902, 904, 906, 908, 916 and 918 may be similar to those in the existing solution, and the components 910, 912 and 914 implemented as software (SW) components are new added components. The first determination module 802 of FIG. 8 is implemented as the PTP clock recovery unit 908, the second determination module 804 of FIG. 8 is implemented as including the phase detector 910 and the PTP path detector 912, the synchronizing module 806 of FIG. 8 is implemented as the phase offset adjuster 916, and the updating module 808 of FIG. 8 is implemented as the phase compensator 914 in this embodiment. Note that except the necessary hardware components (e.g. the port 902, the timestamp unit 904, the PTP local clock 918), other components of the network device may be implemented either as a dedicated hardware, as a software instance running on a dedicated hardware, or as a virtualized function instantiated on an appropriate platform, e.g. on a cloud infrastructure.

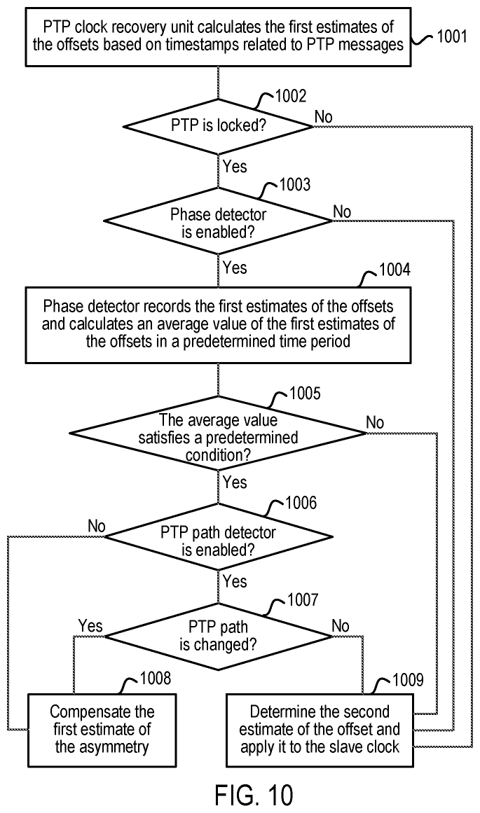

FIG. 10 is a flowchart illustrating a method performed by the network device of FIG. 9. At block 1001, the PTP clock recovery unit calculates the first estimates of the offsets based on timestamps related to PTP messages. This may be implemented in a way similar to block 402. At block 1002, the network device determines whether or not PTP is in locked state. If it is determined at block 1002 that PTP is not in locked state, the method proceeds to block 1009 where the second estimate of the offset is determined and applied to the PTP local clock. On the other hand, if it is determined at block 1002 that PTP is in locked state, the network device determines, at block 1003, whether or not the phase detector is enabled. For example, a configurable parameter “Phase Offset Detector” may be introduced to enable/disable the phase offset detector function.

If it is determined at block 1003 that the phase detector is not enabled, the method proceeds to block 1009. On the other hand, if it is determined at block 1003 that the phase detector is enabled, the phase detector records the first estimates of the offsets calculated by the PTP clock recovery unit, and calculates an average value of the first estimates of the offsets in a predetermined time period (or window) at block 1004. For example, a configurable parameter “Phase offset period” may be introduced to calculate the average of the first estimates of the offsets in the window.

At block 1005, the phase detector determines whether or not the average value satisfies a predetermined condition, e.g. whether or not the difference (which may be denoted as compensation_B described above) between the second estimate of the asymmetry (e.g. the average value calculated at block 1004) and the first estimate of the asymmetry exceeds a threshold range. For example, a configurable parameter “Phase Offset Threshold” may be introduced to check if the average value is in the range of the threshold configured.

If it is determined at block 1005 that the predetermined condition is not satisfied, the method proceeds to block 1009. On the other hand, if it is determined at block 1005 that the predetermined condition is satisfied, the network device determines whether or not the PTP path detector is enabled. For example, a configurable parameter “PTP Path Detector” may be introduced to enable/disable the PTP path detector function.

If it is determined at block 1006 that the PTP path detector is not enabled, the method proceeds to block 1008 where the first estimate of the asymmetry is compensated according to the above equation (6). On the other hand, if it is determined at block 1006 that the PTP path detector is enabled, the PTP path detector determines whether or not the PTP path is changed at block 1007. If it is determined at block 1007 that the PTP path is changed, the method proceeds to block 1008. On the other hand, if it is determined at block 1007 that the PTP path is not changed, the method proceeds to block 1009. After block 1009, the PTP local clock distributes the clock to the timestamp unit for timestamping. With the method of FIG. 10, because the change of the asymmetry can be automatically compensated, the local clock can be avoided from distributing big phase change to the downstream due to asymmetry changes in the network, so that the service of the downstream will not be disturbed.

For ease of understanding. FIG. 11 illustrates the design of the phase detector in more details. For example, for G.8275,2, since there is PTP non-supported network between the master and the slave, the PTP algorithm used by the PTP clock recovery unit needs a lot of timestamps to remove the stochastic asymmetry and get the offset from the master. The PTP algorithm could get a set of first estimates of the offsets based on a large number of timestamps, for example, First estimate (i) of offset, i=1 . . . N. The phase detector may record all these first estimates of the offsets, and windows several first estimates as a period. The average value of the first estimates in the window may be calculated and recorded. Then, the phase detector may determine whether the average value satisfies a predetermined condition, by comparing the difference between the average value and the first estimate of the asymmetry with a threshold range. If it is within the threshold range, block 1009 may be performed to adjust the phase in the local clock. If it exceeds the threshold range, it may be sent to the PTP path detector or the PTP path detector may be triggered to operate. The PTP path detector may check if there is any PTP path change. If there is no PTP path change, block 1009 may be performed to adjust the phase in the local clock. Otherwise, block 1008 may be performed to compensate the asymmetry.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a network device, comprising:
determining first estimates of offsets between a slave clock of the network device acting as a precision time protocol (PTP) slave and a master clock of a PTP master, based on timestamps related to PTP messages communicated between the network device and the PTP master;
determining whether there is a change in at least one of a first path from the network device to the PTP master and a second path from the PTP master to the network device;
when determining that there is no change in the first path and the second path, synchronizing the slave clock with the master clock based on the first estimates of the offsets and a first estimate of asymmetry between a first propagation delay from the network device to the PTP master and a second propagation delay from the PTP master to the network device; and
when determining that there is a change in at least one of the first path and the second path, updating the first estimate of the asymmetry based on the first estimates of the offsets.

2. The method according to claim 1, wherein determining whether there is a change in at least one of the first path and the second path comprises:
determining a second estimate of the asymmetry based on the first estimates of the offsets; and
determining whether there is a change in at least one of the first path and the second path, based on the second estimate of the asymmetry and the first estimate of the asymmetry.

3. The method according to claim 2, wherein when a difference between the second estimate of the asymmetry and the first estimate of the asymmetry exceeds a predetermined threshold range, it is determined that there is a change in at least one of the first path and the second path; and
wherein when the difference is within the predetermined threshold range, it is determined that there is no change in the first path and the second path.

4. The method according to claim 2, wherein updating the first estimate of the asymmetry comprises:
updating the first estimate of the asymmetry to be equal to the second estimate of the asymmetry.

5. The method according to claim 1, wherein determining whether there is a change in at least one of the first path and the second path comprises:
obtaining routing information related to the first path and the second path; and
determining whether there is a change in at least one of the first path and the second path, based on the obtained routing information.

6. The method according to claim 5, wherein the routing information is obtained by using one or more of:
a traceroute process; and
an interior gateway protocol (IGP) process.

7. The method according to claim 5, wherein updating the first estimate of the asymmetry comprises:
determining a second estimate of the asymmetry based on the first estimates of the offsets; and
updating the first estimate of the asymmetry to be equal to the second estimate of the asymmetry.

8. The method according to claim 5, wherein
whether there is a change in at least one of the first path and the second path is determined based on the obtained routing information and the first estimates of the offsets.

9. The method according to claim 8, wherein it is determined that there is no change in the first path and the second path when one of following conditions is satisfied:
a difference between a second estimate of the asymmetry based on the first estimates of the offsets and the first estimate of the asymmetry exceeds a predetermined threshold range, but the obtained routing information shows that there is no change in the first path and the second path; and
the difference is within the predetermined threshold range.

10. The method according to claim 1, wherein synchronizing the slave clock with the master clock based on the first estimates of the offsets and the first estimate of the asymmetry comprises:
determining a second estimate of the offset based on the first estimates of the offsets and the first estimate of the asymmetry; and
adjusting the slave clock based on the second estimate of the offset.

11. The method according to claim 1, wherein the PTP messages comprise a plurality of message groups communicated during a predetermined time period, each message group including a Sync message, a Follow Up message, a Delay Request message, and a Delay Response message; and
wherein the timestamps comprise a plurality of timestamp groups corresponding to the plurality of message groups, each timestamp group including a first timestamp at which the Sync message is sent from the PTP master, a second timestamp at which the Sync message is received by the network device, a third timestamp at which the Delay Request message is sent from the network device, and a fourth time stamp at which the Delay Request message is received by the PTP master.

12. The method according to claim 11, wherein for a message group, the first estimate of the offset is determined as 0.5 multiplied by a difference between a first difference between the second and first timestamps and a second difference between the fourth and third timestamps.

13. The method according to claim 2, wherein the second estimate of the asymmetry is determined as an opposite value of an average value of: the first estimates of the offsets or the filtered first estimates of the offsets.

14. The method according to claim 10, wherein the second estimate of the offset is determined as a sum of the first estimate of the asymmetry and an average value of the first estimates of the offsets or the filtered first estimates of the offsets.

15. The method according to claim 1, wherein the network device is one of:
a partial-support telecom boundary clock (T-BC-P) device;
an assisted partial-support telecom boundary clock (T-BC-A) device;
a partial-support telecom time slave clock (T-TSC-P) device; and
an assisted partial-support telecom time slave clock (T-TSC-A) device.

16. A network device comprising:
at least one processor; and
at least one memory containing instructions executable by the at least one processor, whereby the network device is operative to:
determine first estimates of offsets between a slave clock of the network device acting as a precision time protocol (PTP) slave and a master clock of a PTP master, based on timestamps related to PTP messages communicated between the network device and the PTP master;
determine whether there is a change in at least one of a first path from the network device to the PTP master and a second path from the PTP master to the network device;
when determining that there is no change in the first path and the second path, synchronize the slave clock with the master clock based on the first estimates of the offsets and a first estimate of asymmetry between a first propagation delay from the network device to the PTP master and a second propagation delay from the PTP master to the network device; and
when determining that there is a change in at least one of the first path and the second path, update the first estimate of the asymmetry based on the first estimates of the offsets.

17. (canceled)

18. A computer readable storage medium storing thereon instructions, which when executed by at least one processor, cause the at least one processor to:
determine first estimates of offsets between a slave clock of the network device acting as a precision time protocol (PTP) slave and a master clock of a PTP master, based on timestamps related to PTP messages communicated between the network device and the PTP master;
determine whether there is a change in at least one of a first path from the network device to the PTP master and a second path from the PTP master to the network device;
synchronize the slave clock with the master clock based on the first estimates of the offsets and a first estimate of asymmetry between a first propagation delay from the network device to the PTP master and a second propagation delay from the PTP master to the network device, when determining that there is no change in the first path and the second path; and
update the first estimate of the asymmetry based on the first estimates of the offsets, when determining that there is a change in at least one of the first path and the second path.
